(19) United States
(12) Patent Application Publication
(10) Pub. No.: US 2009/0222839 A1
(43) Pub. Date: Sep. 3, 2009

(54) Methods and Systems for Diagnostic Control of a Device

(75) Inventors: Andrew R. Ferlitsch, Camas, WA (US); Roy K. Chrisop, Camas, WA (US)

Correspondence Address: Kristine Elizabeth Matthews, 19302 SE 31st Drive, Camas, WA, 98607, US

(73) Assignee: Sharp Laboratories of America, Inc.,

(21) Appl. No.: 12/040,613

(22) Filed: Feb. 29, 2008

(51) Int. Cl. G06F 3/00; G06F 9/44

(52) U.S. Cl. 719/318; 710/15

(57) ABSTRACT

Aspects of the present invention are related to systems and methods for automatically loading diagnostic controlling applications for a device.

### FIELD OF THE INVENTION

Embodiments of the present invention comprise methods and systems for automatically loading diagnostic controlling applications for a device.

### BACKGROUND

When a device generates an event notification that may require user intervention or other service intervention, diagnosis of the problem is often limited to visual inspection of the device or to pre-configured diagnostic programs residing on the device. The operation of a device may be enhanced by a diagnostic functionality provided by a remote application.

### SUMMARY

Some embodiments of the present invention comprise methods and systems for automatically loading diagnostic controlling applications for a device. Some embodiments of the present invention comprise methods and systems wherein one or more diagnostic controlling applications may be associated with one or more monitored events which may occur on a device. Some embodiments of the present invention comprise determining candidate diagnostic controlling applications based on an occurrence of a registered event, or events. Some embodiments of the present invention comprise controlling a device with a selected diagnostic controlling application from a hosted computing environment which may be, in some embodiments, on a remote computing device. In alternative embodiments, the hosted computing environment may be a guest operating system on the device. In yet other alternative embodiments, the hosted computing environment may be a virtualized operating environment deployed on a local network or wide area network, for example, the Internet.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a picture showing an exemplary embodiment of the present invention comprising an imaging device, a remote server, a remote computing device and a remote data store;

FIG. 2 is a picture showing an exemplary embodiment of the present invention comprising a device, a remote computing device and a remote data store;

FIG. 3 is chart showing exemplary embodiments of the present invention comprising determining candidate diagnostic controlling applications based on an occurrence of a registered event;

FIG. 4 is a chart showing exemplary embodiments of the present invention comprising determining candidate diagnostic controlling applications based on registered events;

FIG. 5 is chart showing exemplary embodiments of the present invention comprising selecting a diagnostic controlling application from a plurality of candidate diagnostic controlling applications based on a ranking;

FIG. 6 is a chart showing exemplary embodiments of the present invention comprising suspending execution of a task at a device and controlling the device with a selected diagnostic controlling application; and

FIG. 7 is a chart showing exemplary embodiments of the present invention comprising sending a notification of the occurrence of a monitored event from a device to a remote computing device.

### DETAILED DESCRIPTION OF EXEMPLARY EMBODIMENTS

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods and systems of the present invention is not intended to limit the scope of the invention but it is merely representative of the presently preferred embodiments of the invention.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

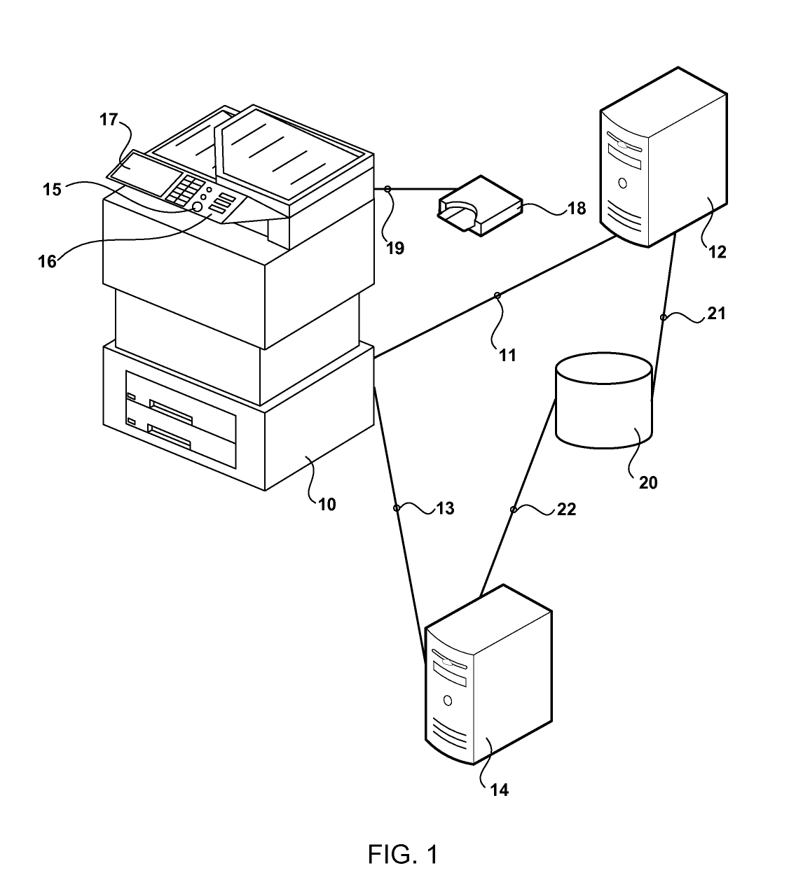

Exemplary embodiments of the present invention may be described in relation to FIG. 1. These exemplary embodiments may comprise an imaging device 10. In some embodiments, the imaging device 10 may take the form of a multi-function peripheral device (MFP) that combines the functions of two or more traditionally separated imaging devices. An MFP may combine any number of imaging devices, but typically comprises the functions of one or more of the following exemplary imaging devices: a printer, a scanner, a copier, a filing device, a document management device, a publishing device, a media duplication device, a display device and a fax machine. In alternate embodiments, the imaging device 10 may take the form of a single-function imaging device. Exemplary single-function imaging devices comprise a printer, a scanner, a copier, a filing device, a document management device, a publishing device, a media duplication device, a display device and a fax machine.

The imaging device 10 may be connected to a remote computing device 12 and/or a remote server 14. In some embodiments, the remote computing device 12 and the remote server 14 may be distinct. In alternate embodiments, the remote computing device 12 and the remote server 14 may be the same device.

The connection 11 between the imaging device 10 and the remote computing device 12 may be any communications link, such as a network connection, a telephone line (PSTN), a serial cable or some other wired or wireless communications link. Communication and transport of data between the imaging device 10 and the remote computing device 12 may be by any protocol or combination of protocols, of which exemplary protocols may comprise WS/SOAP (Web Services/Simple Object Access Protocol), SOAP/XML (Simple Object Access Protocol/eXtensible Markup Language), DIME (Direct Internet Message Encapsulation), FTP (File Transfer Protocol), NFS (Network File System), SMTP (Simple Mail Transfer Protocol), HTTP/HTML (HyperText Transfer Protocol/HyperText Markup Language), Email, a proprietary protocol over TCP/IP (Transmission Control Protocol/Internet Protocol) and AppleTalk®.

The connection 13 between the imaging device 10 and the remote server 14 may be any communications link, such as a network connection, a telephone line (PSTN), a serial cable or some other wired or wireless communications link. Communication and transport of data between the imaging device 10 and the remote server 14 may be by any protocol or combination of protocols, of which exemplary protocols may comprise WS/SOAP, SOAP/XML, DIME, FTP, NFS, SMTP, HTTP/HTML, Email, a proprietary protocol over TCP/IP and AppleTalk®.

The imaging device 10 may further comprise a user interface (UI) panel 16, which may comprise input buttons 15 and a display device 17. In some embodiments, the display device 17 may comprise a touch panel system with or without input buttons 15.

The imaging device 10 may be communicatively coupled 19 with removable or external storage 18 via a hostless or hosted connection. Exemplary removable or external storage systems may comprise a USB (Universal Serial Bus) thumb drive, a memory stick reader, a CD-ROM/DVD (Compact Disk-Read Only Memory/Digital Versatile Disc) drive, a floppy disk drive, a cellular telephone, a PDA (Personal Digital Assistant), an FTP site, an HTTP site and network (or otherwise remote) mounted file system or storage. The connection 19 between the imaging device 10 and the removable or external storage 18 may be any communications link, such as a network connection, a telephone line, a serial cable or some other wired or wireless communications link. Communication and transport of data between the imaging device 10 and the removable or external storage 18 may be by any protocol or combination of protocols, of which exemplary protocols may comprise WS/SOAP, SOAP/XML, DIME, FTP, NFS, SMTP, HTTP/HTML, a proprietary protocol over TCP/IP and AppleTalk®. In some embodiments, the imaging device 10 may comprise an integral coupling mechanism for accessing removable or external storage. Exemplary integral coupling mechanisms may comprise a USB port, a parallel port, a serial port, a memory stick reader, a CD/DVD drive and a floppy disk drive.

In some embodiments, the display device 17 may be under the control of an external application, which may be hosted on the remote computing device 12, the remote server 14 or another computing host (not shown). In some embodiments, the external application may control the display device 17 via web services. In some embodiments, the external application may be a diagnostic controlling application.

In some embodiments, the imaging device 10 may be under the control of an external application, which may be hosted on the remote computing device 12, the remote server 14, or another computing host (not shown). In some embodiments, the external application may control the imaging device 10 via web services. In some embodiments, the external application may be a diagnostic controlling application.

In some embodiments, one or more diagnostic controlling applications may be stored on a data store 20 that is communicatively coupled to one or more remote computing devices (one shown 12) and/or one or more remote servers (one shown 14). In some embodiments, a data store may be communicatively coupled with the imaging device 10. In some embodiments, the data store may be internally hosted. Exemplary internally hosted data stores include hard disks, flash storage and other internal data stores. In alternative embodiments, the data store may be externally hosted, for example through a data-store service. In still alternative embodiments, the data store may comprise removable storage.

The connection 21 between the data store 20 and the remote computing device 12 may be any communications link, such as a network connection, a telephone line (PSTN), a serial cable or some other wired or wireless communications link. Communication and transport of data between the data store 20 and the remote computing device 12 may be by any protocol or combination of protocols, of which exemplary protocols may comprise WS/SOAP, SOAP/XML, DIME, FTP, NFS, SMTP, HTTP/HTML, Email, a proprietary protocol over TCP/IP and AppleTalk®.

The connection 22 between the data store 20 and the remote server 14 may be any communications link, such as a network connection, a telephone line, a serial cable or some other wired or wireless communications link. Communication and transport of data between the data store 20 and the remote server 14 may be by any protocol or combination of protocols, of which exemplary protocols may comprise WS/SOAP, SOAP/XML, DIME, FTP, NFS, SMTP, HTTP/HTML, Email, a proprietary protocol over TCP/IP and AppleTalk®.

Embodiments of the present invention comprise methods and systems for controlling an imaging device with a controlling application that may be remote to the imaging device. U.S. patent application Ser. No. 10/962,248, entitled “Methods and Systems for Imaging Device Remote Application Interaction,” describes methods and systems for controlling an imaging device from a remote computing device, and U.S. patent application Ser. No. 10/962,248 is hereby incorporated by reference herein in its entirety.

Some embodiments of the present invention may use a controlling application that may not have been previously installed on a remote server or a remote computing device. Some embodiments of the present invention may use a controlling application that may not have been previously registered by the imaging device or may not have been previously discovered by the imaging device. U.S. patent application Ser. No. 11/620,434, entitled “Methods and Systems for Controlling an Imaging Device,” describes methods and systems for loading applications, from a data store, for controlling an imaging device from a remote computing device, and U.S. patent application Ser. No. 11/620,434 is hereby incorporated by reference herein in its entirety.

In some embodiments, the controlling application may control the UI for the imaging device front panel. In some embodiments, the controlling application may interpret responses input through the imaging device UI. In some embodiments, the controlling application may control imaging device functions (e.g., scan and print operations). In some embodiments, the controlling application may control pre-processing operations or may control post-processing operations. An exemplary pre-processing operation may be converting file data into printer-ready data. An exemplary post-processing operation may be OCR (Optical Character Recognition) of scanned image data. In some embodiments, the controlling application may be a diagnostic controlling application which may control diagnostic operations on the imaging device. In some embodiments, the controlling application may perform a service related to the imaging device, for example, ordering consumables and other services.

Alternative embodiments of the present invention may comprise a device other than an imaging device. Exemplary devices include an audio/visual (A/V) record/playback device, a duplication device (for example, a CD, a DVD and other duplication devices), a computing device (for example, a client computing device, a server and other computing devices), a mobile device (for example, a PDA, a cellular telephone and other mobile devices), a household appliance (for example, a washer, a dryer, an oven and other household appliances) and other devices.

Some embodiments of the present invention may comprise a hardware device of which exemplary hardware devices are enumerated above. Alternative embodiments of the present invention may comprise a software device, a composition of devices or a virtual device.

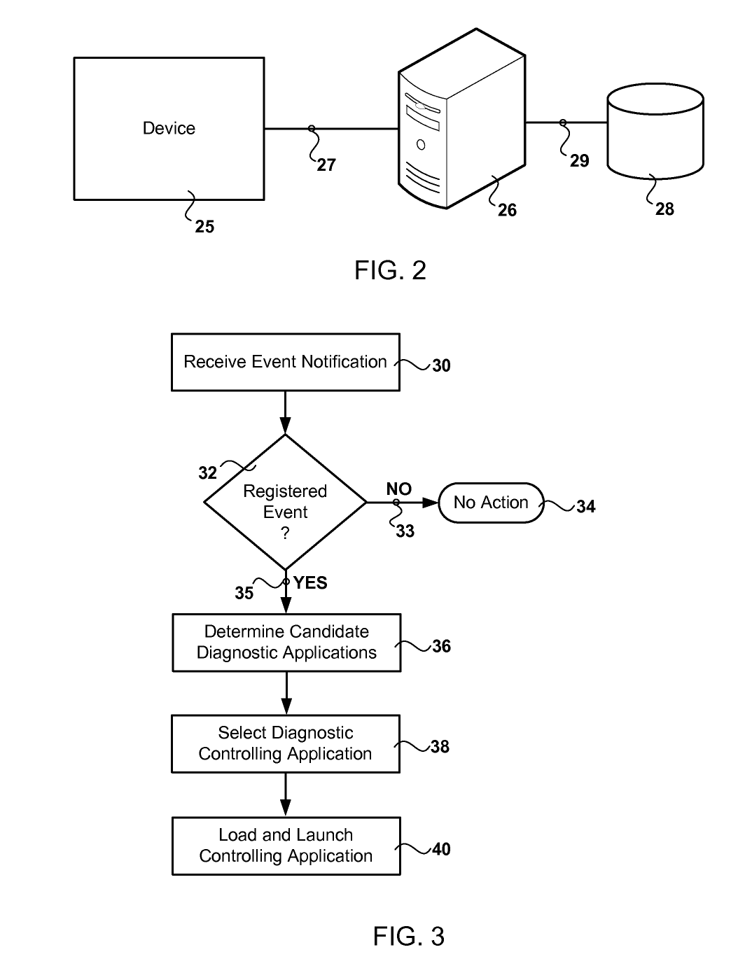

In some embodiments of the present invention illustrated in relation to FIG. 2, a device 25 may be communicatively coupled with an external computing device 26. The connection 27 between the device 25 and the external computing device 26 may be any communications link, such as a network connection, a telephone line (PSTN), a serial cable or some other wired or wireless communications link. Communication and transport of data between the device 25 and the external computing device 216 may be by any protocol or combination of protocols, of which exemplary protocols may comprise WS/SOAP, SOAP/XML, DIME, FTP, NFS, SMTP, HTTP/HTML, Email, a proprietary protocol over TCP/IP and AppleTalk®.

The external computing device 26 may be communicatively coupled with a data store 28. The connection 29 between the data store 28 and the external computing device 26 may be any communications link, such as a network connection, a telephone line (PSTN), a serial cable or some other wired or wireless communications link. Communication and transport of data between the data store 28 and the external computing device 26 may be by any protocol or combination of protocols, of which exemplary protocols may comprise WS/SOAP, SOAP/XML, DIME, FTP, NFS, SMTP, HTTP/HTML, Email, a proprietary protocol over TCP/IP and AppleTalk®.

In some embodiments of the present invention illustrated in relation to FIG. 2, the device 25 may be an imaging device. In alternative embodiments, the device 25 may be a device other than an imaging device. In some embodiments, the device 25 may be an MFP. Exemplary external computing devices 26 include server devices and other computing devices. In some embodiments of the present invention, the data store 28 may be external to the external computing device 26. In alternative embodiments, the data store 28 may be internal or otherwise integrated to the external computing device 26. In some embodiments of the present invention, one or more diagnostic controlling applications for the device 25 may be stored on the data store 28.

A device 25 may generate an event notification indicating the occurrence of an event on the device 25 which may require user, or other service, intervention. In some embodiments of the present invention, an operator may register one or more monitored events such that occurrence of the registered event(s) may trigger an associated diagnostic application, or applications. In some embodiments of the present invention, the diagnostic controlling application may be remote to the device 25.

In exemplary embodiments comprising an imaging device, exemplary monitored events may comprise events associated with paper jams, out-of-consumable, low consumable level, full bins, electromechanical problems, sub-unit failures and warnings, service maintenance cycle, power levels and consumption, job completion, interrupt status, accounting, auditing and other events.

Some embodiments of the present invention may be described in relation to FIG. 3. An external computing device 26 may receive 30 event notification of the occurrence of a monitored event on a device 25. The external computing device 26 may determine 32 if the event is a registered event. A registered event may comprise an event for which a diagnostic application has been registered. If the event is not 33 a registered event, then no further action may be taken 34. If the event is 35 a registered event, candidate diagnostic applications may be determined 36 based on the event. A diagnostic controlling application may be selected 38 from the candidate applications and the selected application may be loaded and launched 40.

In some embodiments of the present invention, the selected application may be loaded in a hosted computing environment. In some embodiments of the present invention, the hosted computing environment may reside on the external computing device 26. In alternative embodiments of the present invention, the hosted computing environment may be a guest operating system within the device 25. In still alternative embodiments of the present invention, the hosted computing environment may be a virtualized operating environment deployed on a local network or wide area network, for example, the Internet. An exemplary virtualized computing environment is cloud computing.

In some embodiments of the present invention, event triggers may be associated with diagnostic controlling applications through a registration process. In some embodiments of the present invention, a plurality of events may be associated with a diagnostic controlling application. In some embodiments of the present invention, a diagnostic controlling application may be identified by a uniform resource locator (URL) or uniform resource indicator (URI).

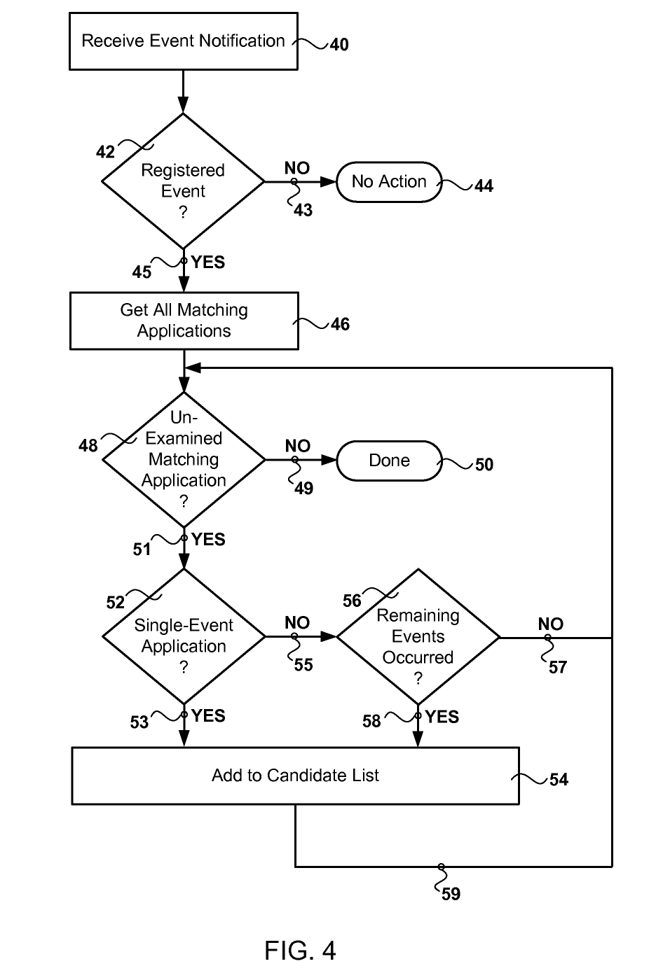

In some embodiments of the present invention, a diagnostic controlling application may be added to the candidate list of applications according to FIG. 4. An external computing device 26 may receive 40 event notification of the occurrence of a monitored event on a device 25. The external computing device 26 may determine 42 if the event is a registered event. A registered event may comprise an event for which a diagnostic application has been registered. If the event is not 43 a registered event, then no further action may be taken 44. If the event is 45 a registered event, candidate diagnostic applications may be determined based on the event.

All diagnostic applications for which occurrence of the received event is necessary for invoking the diagnostic application, also considered diagnostic applications for which the event is registered, may be determined 46 as events matching the received, occurred event. All matching applications may be examined 48. If there are no matching applications remaining 49 to examine, then the candidate list determination may be complete 50.

A remaining 51 un-examined matching application may be examined 52 to determine if the matching application is registered with only a single event. If the single event for which notification has been received is 53 the only event registered for the matching application being examined, then the matching application may be added 54 to the candidate list of diagnostic applications.

If multiple events are registered 55 for the matching application being examined, then the external computing device 26 may determine 56 if all of the events registered for the matching application have occurred. If not 57, then the next un-examined matching application may be examined 48. If all of the events registered for the matching device have occurred 58, then the matching application may be added 54 to the candidate list of diagnostic applications. In some embodiments of the present invention, an event may be considered to have occurred if the event state is still active. An example of a still-active event may comprise a paper jam which persists. In alternative embodiments of the present invention, an event may be considered to have occurred if the event occurred within a predetermined period of time. In another alternative embodiment of the present invention, an event may be considered to have occurred if the number of times the event has occurred exceeds a threshold. In some embodiments, the threshold may be predefined. In alternative embodiments, the threshold may be dynamically determined.

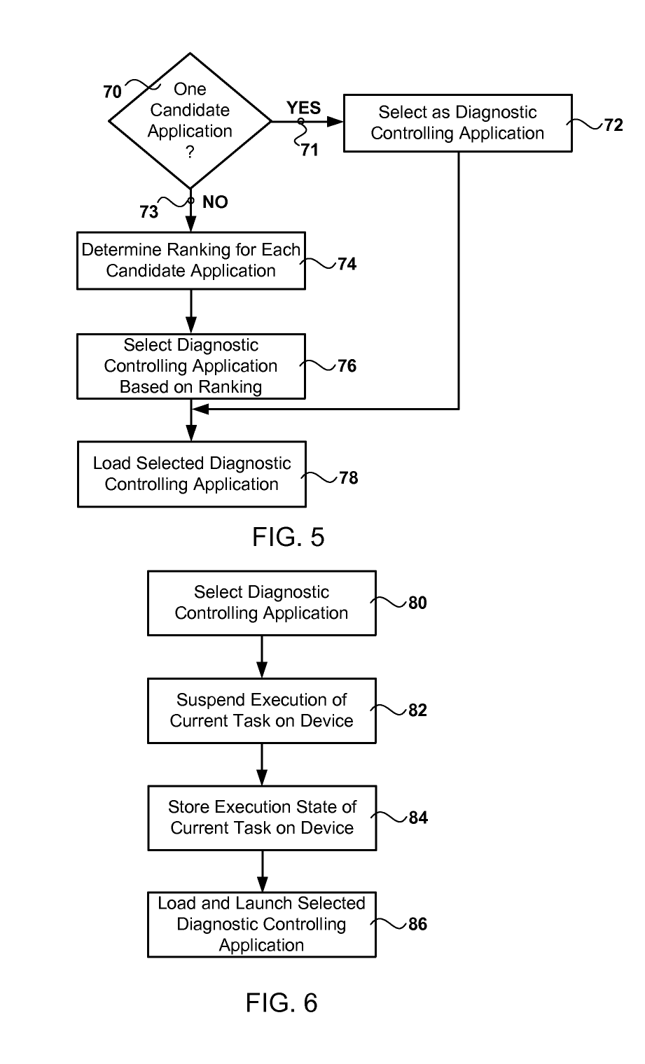

In some embodiments of the present invention, a diagnostic controlling application may be selected from the candidate list of diagnostic applications according to FIG. 5. The candidate list may be examined 70 to determine if it comprises more than one candidate controlling application. If the number of candidate diagnostic controlling applications is only one application 71, then that candidate diagnostic controlling application may be selected 72 as the diagnostic controlling application. The selected diagnostic controlling application may be loaded 78. If the candidate list comprises more than one application 73, then a ranking may be determined 74 for each of the candidate diagnostic controlling applications. A diagnostic controlling application may be selected 76 based on ranking, and the selected diagnostic controlling application may be loaded 78.

In some embodiments of the present invention, a ranking may be associated with a candidate diagnostic controlling application according to the number of events registered for the candidate application. In alternative embodiments of the present invention, a ranking may be associated with a candidate diagnostic controlling application according a severity measure associated with the events registered for the candidate application. In still alternative embodiments of the present invention, a ranking may be associated with a candidate diagnostic controlling application according to a predefined ranking. In still alternative embodiments of the present invention, a ranking may be associated with a candidate diagnostic controlling application based on device parameters. In yet alternative embodiments of the present invention, a ranking associated with a diagnostic controlling event may be a combined ranking based on the above-described methods for rank determination.

In some embodiments of the present invention, after a first diagnostic controlling application has executed, a second diagnostic controlling application from said candidate list may be loaded. In some embodiments of the present invention, all candidate applications may loaded serially based on ranking.

In some embodiments of the present invention, described in relation to FIG. 6, an external computing device 26 may select 80 a diagnostic controlling application. The external computing device 26 may preempt any running controlling application associated with the device 25 by suspending 82 execution and storing 84 the execution state of the currently running task. The external computing device 26 may load and launch 86 the diagnostic controlling application. In alternative embodiments of the present invention, the instructions to preempt any running application and preserve the current application state may be within the diagnostic application itself. In some embodiments of the present invention, the preempted controlling application may be resumed at a later time using the stored execution state.

In some embodiments of the present invention, the diagnostic controlling application may assume control of the device 25 user interface. The diagnostic controlling application may replace the preempted application's interface with the diagnostic controlling application's interface. In some embodiments of the present invention, the diagnostic controlling application may project its interface to one or more remote interfaces associated with the device 25. In some embodiments, a remote interface may be communicatively coupled with the device 25. In alternative embodiments, a remote interface may not be communicatively coupled with the device 25. Exemplary remote interfaces may comprise an interface associated with a device administrator's computing device, an interface at a dealer site associated with the device, an interface at a clerk's terminal at a retail store and other interfaces.

In some embodiments of the present invention, the device may initiate, also considered pull, the loading of the user interface. In alternative embodiments of the present invention, the hosted computing environment may initiate, also considered push, the loading of the user interface.

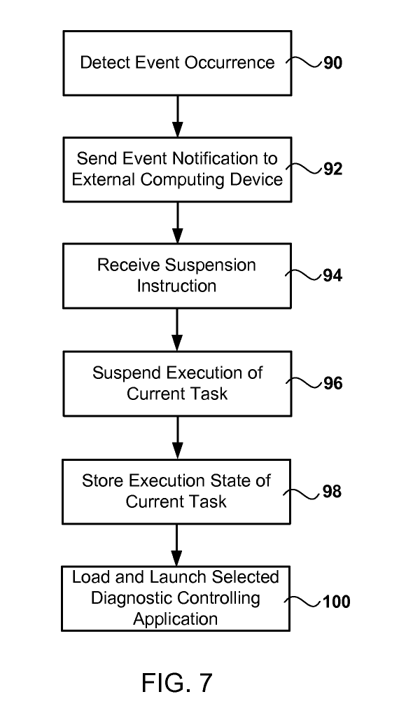

Some embodiments of the present invention may be described in relation to FIG. 7. In these embodiments, an event may be detected 90 at a device. Notification of the event may be sent 92 to a remote computing device from the device. The device may receive 94 an instruction to suspend execution of the application currently controlling the device. In some embodiments, the suspension instruction may be sent from the remote computing device to which the device sent the event notification. In alternative embodiments, the suspension instruction may be sent from a second remote computing device. The device may suspend 96 execution of the current task, also considered application. The device may store 98 the execution state of the suspended task in order to resume the suspended task at a later time. In some embodiments, the device may store the execution state locally. In alternative embodiments, the device may send the execution state to a remote computing device for storage. In still alternative embodiments, the device may store the execution state on a remote storage device which is communicatively coupled to the device. A selected diagnostic controlling application may be loaded at a hosting server and launched 100, wherein the selected diagnostic controlling application controls the device. In some embodiments, the device may directly launch the selected diagnostic controlling application. In alternative embodiments, the hosting server may launch the selected diagnostic controlling application. In some embodiments, a plurality of diagnostic controlling applications may be loaded and launched serially, wherein each diagnostic controlling application in the plurality of diagnostic controlling applications is associated with the occurring event of which the device notified 92 the remote computing device.

In some embodiments of the present invention, a diagnostic controlling application may control a device from a remote hosting server. The diagnostic controlling program may communicate with, interact with or operate the device. In some embodiments, the diagnostic program may communicate with, interact with or operate the device via the UI controls on a diagnostic UI and via device controls sent the device's programmatic interface. For example, the device may automatically pull the front application service provider (ASP) page of the diagnostic application and render the front ASP page on the front panel UI, as it would with a native application.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

What is claimed is:

1. A method for diagnostic control of a device, said method comprising:
a) at a first remote computing device, receiving a notification of at least one event occurrence on a first device;
b) determining a plurality of candidate diagnostic controlling applications based on said at least one event occurrence;
c) selecting a first diagnostic controlling application from said plurality of candidate diagnostic controlling applications;
d) loading said first diagnostic controlling application on a hosted computing environment, wherein said hosted computing environment is communicatively coupled with said first device; and
e) controlling at least one function of said first device from said hosted computing environment using said first diagnostic controlling application.

2. A method according to claim 1 further comprising:
a) preempting a first controlling application on said first device; and
b) storing a first state associated with said first controlling application.

3. A method according to claim 1, wherein said determining and said selecting are performed at said first remote computing device.

4. A method according to claim 1, wherein said determining and said selecting are performed at a second remote computing device.

5. A method according to claim 1 further comprising:
a) selecting a second diagnostic controlling application from said plurality of candidate diagnostic controlling applications; and
b) loading said second diagnostic controlling application on said hosted computing environment upon completion of said first diagnostic controlling application.

6. A method according to claim 1 further comprising monitoring said first device, from said first remote computing device, for said at least one event occurrence.

7. A method according to claim 6, wherein said monitoring comprises periodic polling.

8. A method according to claim 1, wherein said hosted computing environment is on said first remote computing device, on a second remote computing device, on a computing environment on a storage system, on a virtualized computing environment or a guest operating environment on said first device.

9. A method according to claim 1, wherein said loading further comprises:
a) a first communication to said hosted computing environment from said first remote computing device, wherein said first communication effectuates said hosted computing environment extracting said first diagnostic controlling application from a first storage system; and
b) a second communication to said hosted computing environment from said first remote computing device, wherein said second communication effectuates said hosted computing environment self-loading said first diagnostic controlling application.

10. A method as described in claim 1, wherein said first diagnostic controlling application is stored on a first storage system.

11. A method as described in claim 1, wherein said first device comprises an imaging device.

12. A method as described in claim 11, wherein said imaging device comprises a multi-function peripheral.

13. A method as described in claim 1, wherein the basis for said selecting is a severity associated with said at least one event occurrence, an event ranking associated with said at least one event occurrence or the number of events comprising said at least one event.

14. A method for diagnostic control of a device, said method comprising:
a) from a first device to a first remote computing device, sending a notification of at least one event occurrence on said first device, wherein said remote computing device is communicatively coupled with said first device;
b) determining a plurality of candidate diagnostic controlling applications based on said at least one event occurrence;
c) selecting a first diagnostic controlling application from said plurality of candidate diagnostic controlling applications;
d) loading said first diagnostic controlling application on a hosted computing environment, wherein said hosted computing environment is communicatively coupled with said first device; and
e) controlling said at least one function of said first device from said hosted computing environment using said first diagnostic controlling application.

15. A method as described in claim 14, wherein said first diagnostic controlling application is stored on a first storage system.

16. A method according to claim 14, wherein said determining and said selecting are performed at said first remote computing device.

17. A method according to claim 14, wherein said determining and said selecting are performed at a second remote computing device.

18. A method according to claim 14 further comprising:
a) selecting a second diagnostic controlling application from said plurality of candidate diagnostic controlling applications; and
b) loading said second diagnostic controlling application on said hosted computing environment upon completion of said first diagnostic controlling application.

19. A method as described in claim 14, wherein the basis for said selecting is a severity associated with said at least one event occurrence, an event ranking associated with said at least one event occurrence or the number of events comprising said at least one event.

20. A system for diagnostic control of a device, said system comprising:
a) a first device;
b) a first external computing device, wherein said first external computing device is communicatively coupled with said first device;
c) a first storage system, wherein said first storage system is communicatively coupled with said first external computing device;
d) an event register associating a plurality of events related to said first device with a plurality of diagnostic controlling applications;
e) an event detector for detecting an occurrence of any of said plurality of events on said first device;
f) an event-notification receiver for receiving a first notification of a first occurrence of a first event from said plurality of events;
g) a candidate-application generator for generating a plurality of candidate applications, based on said first event, from said plurality of diagnostic controlling applications in response to said first notification;
h) an application selector for selecting a first diagnostic controlling application from said plurality of candidate applications; and
i) a diagnostic-application launcher for launching said first diagnostic controlling application.
